(19) United States
(12) Patent Application Publication
(10) Pub. No.: US 2006/0181891 A1
(43) Pub. Date: Aug. 17, 2006

(54) MOTORCYCLE TYPE VEHICLE

(76) Inventors: Pisithsak Surawichai, Samutprakarn (TH); Takeshi Okada, Samutprakarn (TH)

Correspondence Address: ERNEST A. BEUTLER, ATTORNEY AT LAW, 10 RUE MARSEILLE, NEWPORT BEACH, CA, 92660, US

(21) Appl. No.: 11/162,754

(22) Filed: Sep. 21, 2005

(30) Foreign Application Priority Data
Feb. 14, 2005 (JP) 2005-036349

(51) Int. Cl. B62J 6/00

(52) U.S. Cl. 362/474; 362/475

(57) ABSTRACT

A lighting arrangement for a handlebar steered vehicle such as a motorcycle wherein a pair of headlights are positioned behind a single lens cover and concealed behind a single opening in a handlebar cover that is configured to make the lights appear as separated and which are commonly vertically adjustable through a controlled range without forming a gap through which the interior of the cover may be viewed.

### BACKGROUND OF THE INVENTION

This invention relates to a motorcycle type vehicle and more particularly to a light arrangement for vehicles of a type steered by a handlebar. Some motorcycles are provided with a dual light unit having a pair of right and left headlights to improve the appearance and lighting therefore. As an example of the prior art structures, Japanese Utility Model JP-U-2526760 discloses a structure in which a pair of right and left headlight openings are formed in a front wall of a cover for the handlebar with a vertical connecting part therebetween so that the right and left headlights are disposed in the right and left headlight openings, respectively. This results in a more expensive arrangement and requires the headlights to be adjusted separately that can present alignment problems.

This situation can be improved by positioning the lights in a common housing behind a single headlight cover. However then the appearance advantage of having paired lights is at least partially lost.

Therefore it is a principal object of the invention to provide a dual lighting arrangement for a vehicle steered by a handlebar where the dual lights are mounted in a common housing but covered in such way as to emphasize the separation between the lights.

In addition to the aforenoted problem, when the entire light unit is moved vertically to adjust the optical axis, a gap is likely to be formed between the light unit and the handlebar cover. This results in an undesirable appearance.

Therefore it is a further object of the invention to provide an adjustable dual headlight assembly and cover arrangement therefore wherein no exposed gap is formed when the entire light unit is moved to adjust the optical axis.

### SUMMARY OF THE INVENTION

A first feature of the invention is adapted to be embodied in a light arrangement for a vehicle of the type steered by a handlebar. The vehicle has a handlebar cover the lighting arrangement comprises a pair of lights disposed on transversely opposite sides of an axis about which the handlebar is dirigible. A single lens cover covers both of the lights. The handlebar cover has a downwardly extending portion that extends over a central portion of the lens cover and between the lights of the pair for providing a visual separation between the lights of the pair.

Another feature of the invention is adapted to be embodied in a dual light arrangement for a motorcycle or like handlebar steered vehicle having a handlebar cover defining an opening. A pair of lights disposed on transversely opposite sides of an axis about which the handlebar is dirigible A single lens cover covering both of said lights and is supported for vertical adjustment behind an opening in the cover. The portion of the handlebar cover defining the opening and the single lens cover having overlapping portions that prevent any direct view behind the opening regardless of the adjusted position of said the lens cover.

### BRIEF DESCRIPTION OF THE DRAWINGS

FIG. 1 is a side elevational view of a vehicle constructed in accordance with an embodiment of the invention.

FIG. 2 is a front elevational view thereof.

FIG. 3 is a rear elevational view thereof.

FIG. 4 is an enlarged front elevational view looking in the same direction as FIG. 1, but showing the forward lighting system.

FIG. 5 is a cross sectional view taken along the line 5-5 of FIG. 4.

FIG. 6 is a cross sectional view taken along the line 6-6 of FIG. 4.

FIG. 7 is a cross sectional view taken along the line 7-7 of FIG. 4.

FIG. 8 is a cross sectional view taken along the same plane as FIG. 5, but shows the positioning light adjusted in one extreme position.

FIG. 9 is a cross sectional view, in part similar to FIG. 8, taken along the same plane as FIG. 5, but shows the positioning light adjusted in the other extreme position.

FIG. 10 is a cross sectional view taken along the same plane as FIG. 6, but shows the head light adjusted in one extreme position.

FIG. 11 is a cross sectional view, in part similar to FIG. 10, taken along the same plane as FIG. 6, but shows the head light adjusted in the other extreme position.

FIG. 12 is a cross sectional view taken along the same plane as FIG. 7, but shows the mechanism adjusted in one extreme position.

FIG. 13 is a cross sectional view, in part similar to FIG. 12, taken along the same plane as FIG. 7, but shows the mechanism adjusted in the other extreme position.

### DETAILED DESCRIPTION

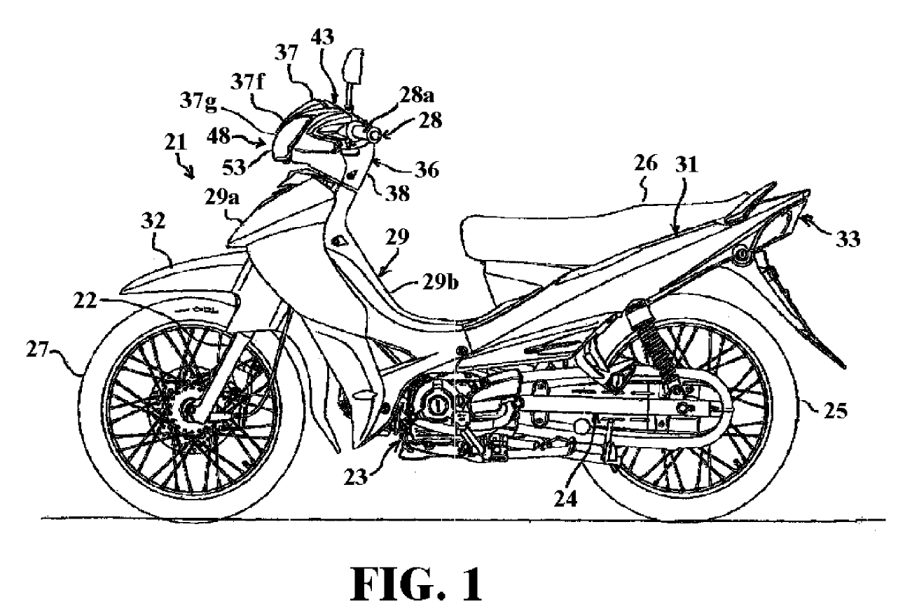

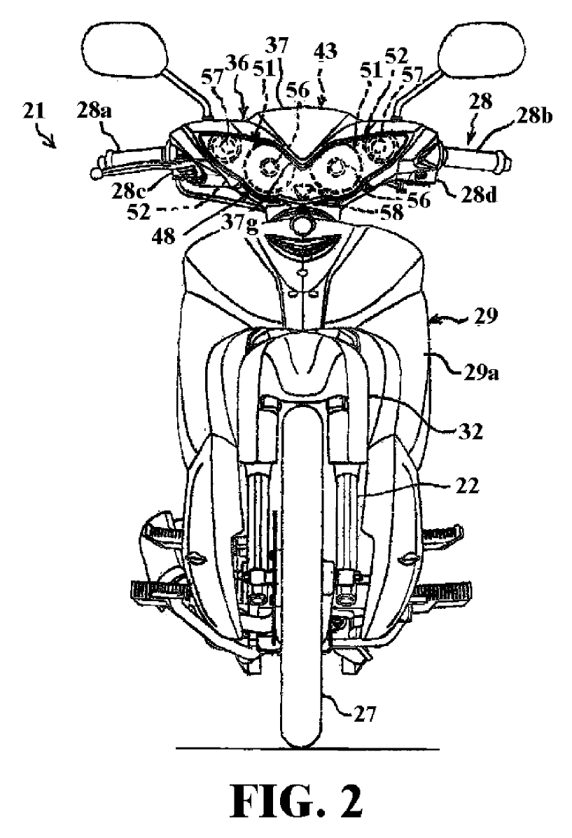

Referring now in detail to the drawings and initially primarily to FIGS. 1-3, a vehicle embodying the invention is designated generally at 21. The particular type of vehicle is a motorcycle but those skilled in the art will readily understand that the invention has particular utility with “motorcycle type vehicles”, these being vehicles normally steered by handlebars such as three or four wheelers, snowmobiles and even some forms of personal watercraft. The motorcycle 21 has a body frame (not shown since it is primarily covered by a body assembly), upon which a front fork 22 is dirigibly supported in a suitable manner at the front end of the body frame. for steering movement. An engine transmission unit 23 is suspended from and supported by an intermediate portion of the body frame forwardly of a rear arm 24. The rear arm 24 is pivotally supported by an intermediate portion of the body frame by a suitable suspension unit for vertical swinging movement. A rear wheel 25 is journalled at the rear end of the rear arm in any suitable fashion. A seat 26 for two persons mounted on an upper rear part of the body frame in part above the rear wheel 25.

A front wheel 27 is rotatably supported at the lower end of the front fork 22. This support may also include a suspension system of a desired type. A steering handlebar assembly 28 is secured to the upper end of the front fork 22 forwardly of the seat 26.

As has been noted, the front and rear halves of the body frame are covered with a by means of a front cover 29 and a rear cover 31, respectively. A front fender 32 is secured to the front fork 22 and covers the upper portion of the front wheel 27.

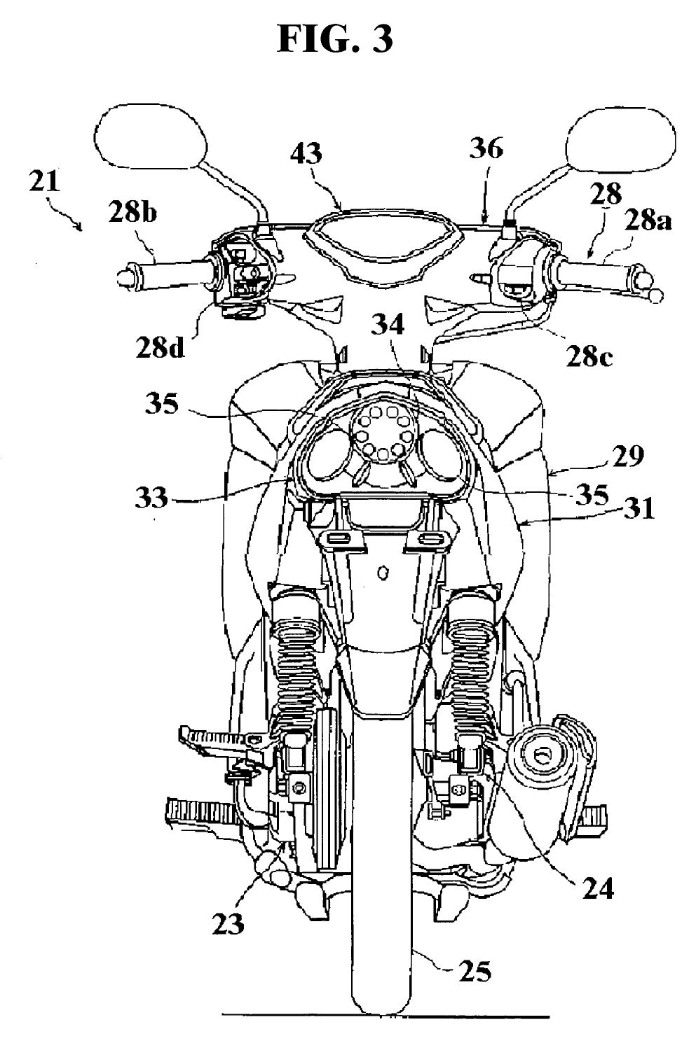

A taillight unit 33, as best seen in FIG. 3, is disposed on a rear wall of the rear cover 31. The taillight unit 33 includes a taillight portion 34 located at the center in the vehicle width direction and a pair of right and left flasher lights 35 on the right and left sides of the taillight portion 34.

Referring now again to the front of the motorcycle 21, the front cover 29 has a front side cover 29a for covering a front side of the body frame and a rear side cover 29b for covering a rear side of the body frame. The front and rear side covers 29a and 29b are secured to the body frame in any suitable manner.

The steering handlebar assembly 28 is surrounded by a handlebar cover 36 made of resin material. The handlebar cover 36 covers the center part of the steering handlebar assembly 28 in the vehicle width direction so that right and left grips 28a and 28b of the steering handlebar assembly 28 and the operation parts of right and left switch boxes 28c, 28d are exposed for operation by the rider.

The handlebar cover 36 is divided into a front cover portion 37 and a rear cover portion 38. The rear cover portion 38 has an upper wall part 38a for covering an upper part of the steering handlebar assembly 28 and a rear wall part 38b extending from a rear edge of the upper wall part 38a for covering a rear part of the steering handlebar assembly 28 and a rear part of a steering shaft 38 that is fixed to the upper end of the front fork 22.

The rear cover portion 38 is secured to the steering shaft 38 and the steering handlebar assembly 28. More specifically, the rear wall part 38b is secured to brackets 40a and 40b secured to the steering shaft 38 by a screw 41 and a bolt 42, respectively (see FIG. 5).

Continuing to refer to FIG. 5, the upper wall part 38a of the rear cover portion 38 has a meter opening 38c, and a meter unit, indicated generally at 43 including, for example, a speedometer and any other desired instruments are disposed in the meter opening 38c.

The front handlebar cover portion 37 has a front wall part 37a for covering a front part of the steering handlebar assembly 28 and a bottom wall part 37b extending backward from a lower edge of the front wall part 37a.

The front handlebar cover portion 37 is secured to the steering handlebar assembly 28 and the rear cover portion 38. More specifically, a pair of right and left fitting projections 37c formed on the front wall part 37a are fitted into brackets 44 secured to the steering handlebar assembly 28 via grommets 45, and a boss part 37d formed on the bottom wall part 37b is secured by a screw 46 inserted from the rear side into a rib 38d of the rear cover portion 38.

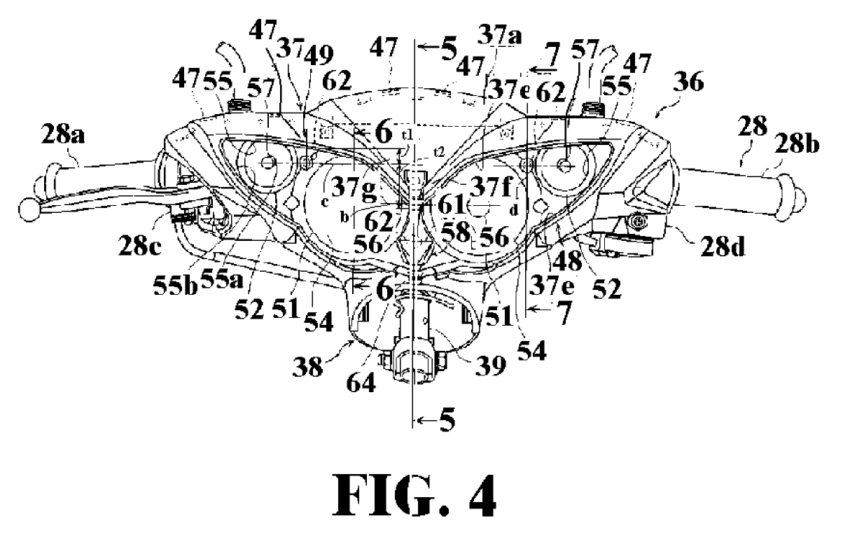

A plurality of positioning engaging parts 42 (FIG. 4) for use in positioning the mating parts of the front and rear covers 32 and 33 are formed along the upper edges of the front and rear covers 32 and 33.

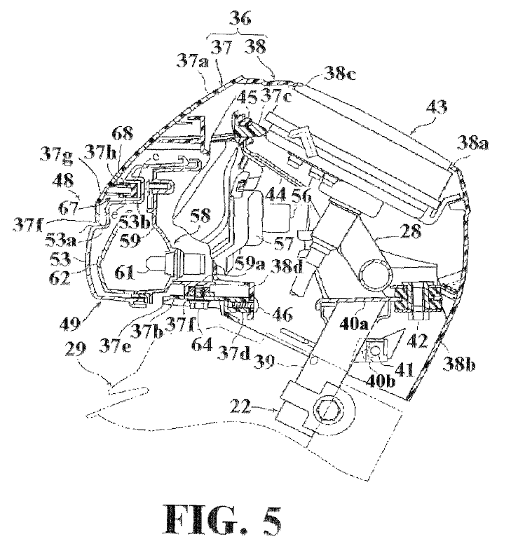

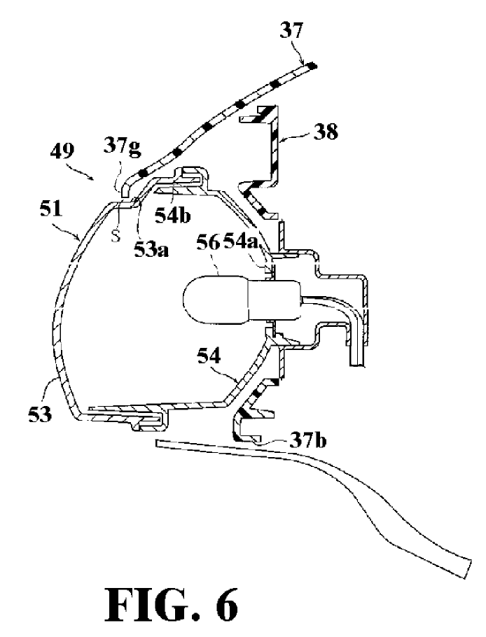

Referring now primarily to FIGS. 5 and 6, a headlight unit 15 is disposed in the handlebar cover 36. The headlight device 15 is constituted as follows.

The front wall part 37a of the front cover portion 37 has a wide headlight opening 37e extending in the vehicle width direction across generally the entire width of the front wall part 37a and configured as will be described in more detail shortly. A light unit, indicated generally at 49 is disposed in the headlight opening 37e.

The light unit 49 is comprised of a pair of transversely spaced right and left headlights 51 and a pair of right and left turn flasher lights 52 disposed transversely outwardly of the headlights 51. A common outer lens 53 covers the front side of the right and left turn flasher lights 52 and the right and left headlights 51. Inner lenses 54 and 55 reflect light from lamp bulbs (light sources) 56 and 57 of the right and left headlights 51 and the right and left turn flasher lights 52, respectively, toward the outer lens 53. It should be noted that in FIG. 4, the outer lens 53 has been removed.

The headlights 51 and the turn flasher lights 52 are arranged symmetrically with respect to a vehicle center line which coincides with the section line 5-5 in FIG. 4. The right and left turn flasher lights 52 have a diameter smaller than that of the headlights 51 and located higher than the headlights 51.

Each of the inner lenses 54 and 55 is of a generally hemispherical shape which opens forwardly. The inner lenses 54 and 55 have bottoms 54a and 55a, respectively, in which the lamp bulbs 56 and 57 are detachably attached. In addition, the inner lenses 54 and 55 have openings 54b and 55b, respectively, in which the outer lens 53 is secured. If desired, the inner lenses 54 and 55 may be formed integrally with each other.

A position lamp 58 which can be turned on separately from the headlights 51 and the turn flasher lights 52 is disposed at a lower part in the space between the right and left headlights 51. The position lamp 58 has an inner lens 59 having a bottom 59a to which a lamp bulb 61 is attached. The outer lens 53 covers the front side of the inner lens 59. Designated as 62 is a lens for changing the color of light from the position lamp 58.

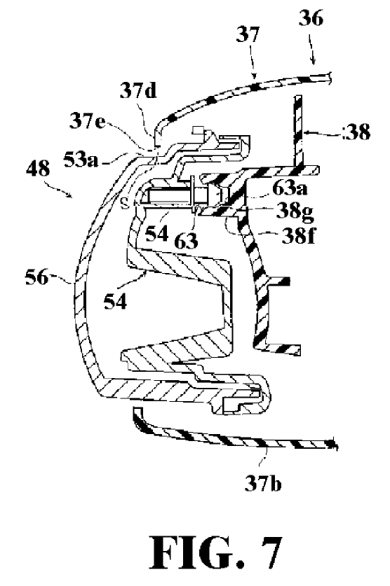

As shown in FIG. 7, boss parts 54c extend rearwardly of the inner lens 54 of each of the right and left headlights 51 from an upper part on the outer side of the vehicle 21. Pivot shafts 63 inserted from the rear side of the vehicle are secured to the boss parts 54c, and each has an engaging part 63a of a generally spherical shape formed at the rear end thereof.

The rear cover portion 38 has right and left supporting parts 38f at positions opposed to the right and left boss parts 54c. Each of the right and left supporting parts 38f has an engaging recess 38g which opens forward. The engaging parts 63a of the pivot shafts 63 are inserted into the right and left engaging recesses 38g. The light unit 49 is thereby supported by the handlebar cover 36 for vertical swinging movement. That is, when the light unit 49 is swung vertically via the right and left pivot shafts 63, the optical axis angles of the lamp bulbs 56 and 57 can be changed simultaneously.

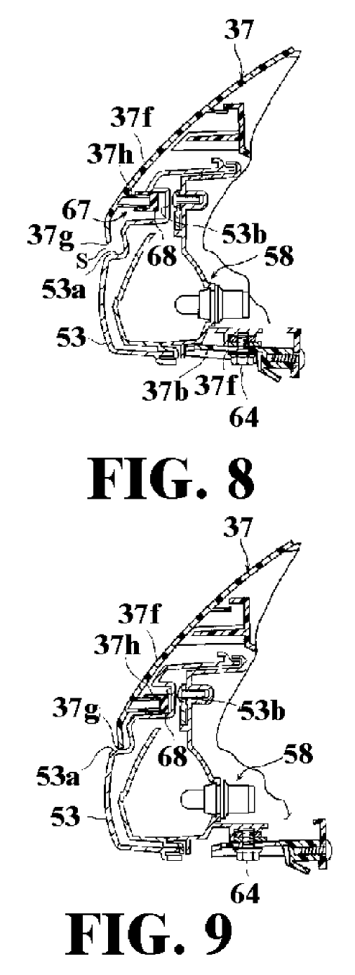

As best seen in FIGS. 5 and 8, a longitudinally extending slot 37f is formed at the center of the bottom wall part 37b of the front cover portion 37. The inner lens 59 of the position lamp 58 bottom 59a extends rearwardly in contact with the upper surface of the portion of the bottom wall part 37b where the slot 37f is formed. An aiming bolt 64 is inserted into the slot 37f and threaded into a nut 65 and washer 66 received in the bottom 59a. When the aiming bolt 64 is loosened, the entire light unit 49 may be swung vertically about the engaging parts 63a of the pivot shafts 63, for adjustment of the optical axis. Then, when the aiming bolt 64 is fastened, the headlights 51 and the turn flasher lights 52 are fixed at a desired optical axis angle.

Referring now primarily to FIG. 4 and as viewed from the front of the vehicle 21, the headlight opening 37e of the front cover portion 37 has an upper edge 37f having an extending part 32g integrally formed therewith and extending downward between the right and left headlights 51.

The extending part 32g extends obliquely downward from the upper edge 37f and has a generally V-shape which becomes narrower in the vehicle width direction from the upper edge 37f to its extending end 32g.

The upper edge 37f has right and left side parts which are slightly inclined upward and outward in the vehicle width direction and cover upper parts of the right and left turn flasher lights 52. The extending part 32g, which extends from the right and left side parts, is inclined downward and inward in the vehicle width direction and covers upper inner edges of the right and left headlights 51.

The lower end of the extending part 32g is located below a line b connecting the centers of the lamp bulbs 56 of the right and left headlights 51 and a line c connecting the centers of the lamp bulbs 57 of the right and left turn flasher lights 52.

As viewed from the front of the vehicle, the position lamp 58 is located below the line b connecting the centers of the lamp bulbs 56 of the right and left headlights 51 and below the lower end of the extending part 32g. The center line of the position lamp 58 in the vehicle width direction coincides with the vehicle center line.

The distance t1 from the center of swinging of each of the right and left pivot shafts 63 to the point, where a vertical line d passing through the center of the pivot shaft 63 and the upper edge 37f intersect, is smaller than the distance t2 from a line c connecting the centers of swinging of the right and left pivot shafts 63 to the end of the extending part 32g. Said another way, the right and left pivot shafts 63 acting as the fulcrums for swinging the light unit 49 are located in the vicinity of the upper edge 37f of the headlight opening 37e.

As best seen in FIG. 5, a coupling mechanism, indicated generally at 67 is disposed between the extending part 37g and the light unit 49. The coupling mechanism 67 is configured to removably couple the light unit 49 and the extending part 37g when the light unit 49 is swung vertically for adjustment of the optical axis thereof. The construction of the coupling mechanism 67 will now be described.

The upper edge 37f of the headlight opening 37e and the lower end of the extending part 37g are opposed to a step part 53a of the outer lens 53 with a prescribed gap therebetween.

At the center of the outer lens 53 in the vehicle width direction, an engaging recess 53b forms one part of the coupling mechanism 67 and opens forward. This recess 53b is formed continuously from the step part 53a. The other part of the coupling mechanism 67 comprises an engaging projection 37h which extends backward from the inner wall of the extending part 37g. An elastic member 68 made of a rubber sponge or the like is fitted on the engaging projection 37h.

The coupling mechanism 67 is so configured such that when the light unit 49 is in an intermediate position in the angle through which it can be swung vertically, there are formed upper and lower gaps (e), (e) between the elastic member 68 and the engaging recess 53b. That is, the engaging projection 37h and the engaging recess 53b are not in contact with each other as seen in FIG. 5. In the present invention, the concept that the light unit 49 and the extending part 37g are removably coupled includes the above non-contact state.

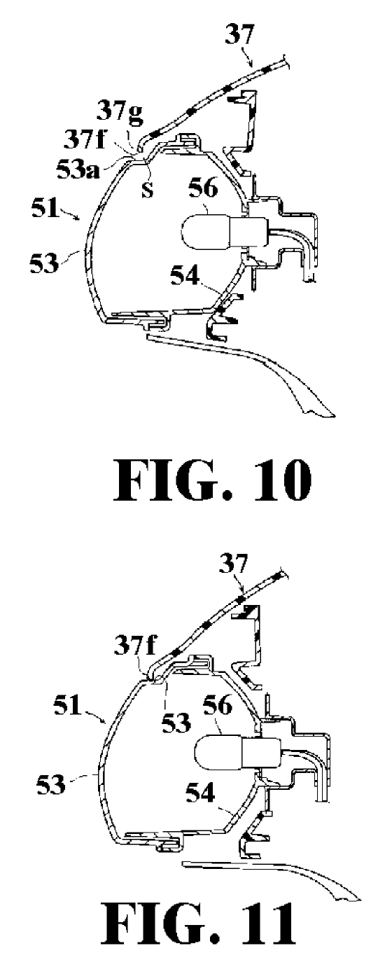

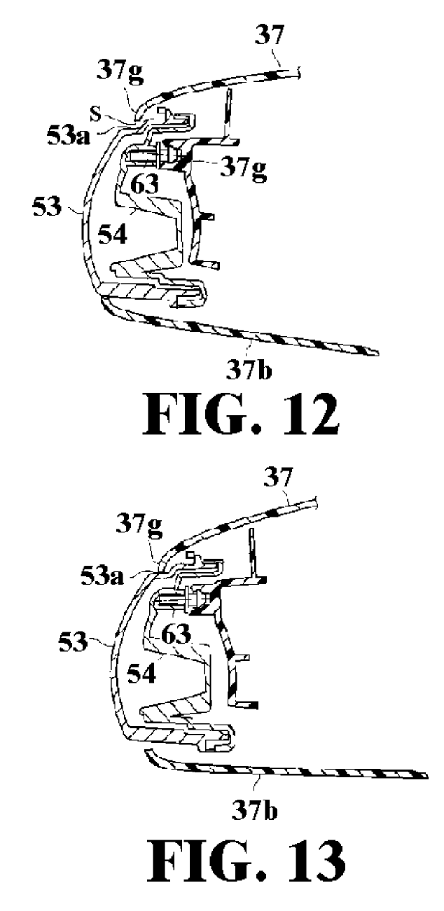

When the light unit 49 is swung downward to its lowermost position as seen in FIG. 8, the elastic member 68 on the engaging projection 37h abuts against an upper part of the engaging recess 53b, and the extending part 37g is drawn downward and elastically deformed. Along with the elastic deformation of the extending part 37g, the upper edge 37f is drawn downward. The resulting gap between the outer lens 53, and the upper edge 37f and the extending part 37g is prevented from becoming excessively wide as seen in FIGS. 8, 10 and 12.

When the light unit 49 is swung upward to its uppermost position, the elastic member 68 on the engaging projection 37h abuts against a lower part of the engaging recess 53b, and the extending part 37g is drawn upward and elastically deformed (see FIG. 8(b)). As a result, the step part 53a of the outer lens 53 is prevented from pressing the extending end 37g of the extending part 32 excessively upward, and the gap is closed as seen in FIGS. 9, 11 and 13.

According to this embodiment, the light unit 49, which is a dual light system having the paired right and left headlights 51 and the paired right and left turn flasher lights 52 disposed outside the headlights 51 in the vehicle width direction, has an improved appearance.

Also in this embodiment, the upper edge 37f of the headlight opening 37e of the handlebar cover 36 has the extending part 37g extending between the right and left headlights 51, and the extending end 32g of the extending part 37g is located below the line b connecting the centers of the lamp bulbs 56 of the right and left headlights 51. Thus, the right and left headlights 51 look divided by the extending part 32 as viewed from a side of or above the vehicle, and look continuous as viewed from the front of or below the vehicle. It is, therefore, possible to provide variations to the appearance of a dual light system and enhance the design effect.

The extending end 32g of the extending part 37g is located below the line b connecting the centers of the lamp bulbs 56. Thus, the handlebar cover 36 extends deeply between the right and left headlights 51 and provides a large variation to the appearance.

In this embodiment, the position lamp 58 is located below the line b connecting the right and left headlights 51 and below the extending end 32g of the extending part 37g. The position lamp 58 is disposed in an extra space defined by the right and left headlights 51 and the extending part 37g.

The extending part 37g has a generally V-shape which becomes narrower in the vehicle width direction from the upper edge 37f to the extending end 32g. Thus, the appearance of the headlight device 15 provided with a dual headlight system can be novel and unconventional.

In this embodiment, the distance t1 from the center of swinging of each of the right and left pivot shafts 63 to the point, where a vertical line (d) passing through the center of the pivot shaft 63 and the upper edge 37f intersect, is smaller than the distance t2 from a line c connecting the right and left pivot shafts 63 to the extending end 32g of the extending part 37g. Thus, the amount, in which the upper edges of the headlights 51 are swung when the light unit 49 is swung vertically about the right and left pivot shafts 63, can be small. Thus, the gap S between the upper edges of the headlights 51 and the upper edge 37f does not become excessively wide or impair the appearance when the optical axis of the light unit 49 is adjusted.

Also, since the pivot shafts 63 are located between the headlights 51 and the turn flasher lights 52, the boss parts for supporting the pivot shafts 63 can be prevented from interfering with the headlights and so on and the arrangement structure of the pivot shafts 63 can be simple.

In this embodiment, since the coupling mechanism 67 for removably coupling the outer lens 53 of the light unit 49 and the extending part 37g when the light unit 49 is moved vertically is interposed between the extending part 37g and the outer lens 53, the extending part 37g is moved together with the light unit 49 when the light unit 49 is swung vertically. Thus, the gap S between the light unit 49 and the extending part 37g does not become excessively wide or impair the appearance when the optical axis of the light unit 49 is adjusted. In addition the overlapping parts of the outer lens 53 and the handlebar cover 36 prevent any view behind the outer lens 53 and the cover 36 regardless of the adjusted position.

The coupling mechanism 67 is comprised of the engaging recess 53b of the outer lens 53 and the engaging projection 37h of the extending part 37g, and the engaging projection 37h is removably engaged with the engaging recess 53b. Since the coupling mechanism 67 is constructed using existing parts without requiring additional parts, an increase in cost can be avoided.

Also, the elastic member 68 fitted on the engaging projection 37h can prevent the engaging projection 37h and the engaging recess 53b from abutting directly against each other and thus prevent noise caused by vibration and so on during running.

In this embodiment, when the light unit 49 is rotated to its uppermost position, the elastic member 68 on the engaging projection 37h abuts against the engaging recess 53 and the extending part 37g is elastically deformed upward. Thus, the gap S between the light unit 49 and the extending part 37g can be small and does not impair the appearance.

In addition, when the light unit 49 is rotated to its lowermost position, the elastic member 68 on the engaging projection 37h abuts against the engaging recess 53b and the extending part 37g is elastically deformed downward. Thus, the step part of the light unit 49 is prevented from pressing the extending part 37g excessively upward, and the appearance is not impaired.

When the light unit 49 is in an intermediate position, the gaps are formed between the elastic member 68 on the engaging projection 37h and the engaging recess 53b. Thus, when the amount, in which the optical axis is adjusted, is small, the extending part 37g is not elastically deformed.

It is needless to say that the elastic member 68, which is provided on the side of the engaging projection 37h in the above embodiment, may be provided on the side of the engaging recess 53b.

Although the extending part is elastically deformed when the lamp unit is swung to its uppermost or lowermost position in the above embodiment, the extending part does not necessarily have to be elastically deformed.

It is needless to say that the application of the present invention is not limited to the above embodiment and as has been noted is not limited to use in the type of vehicle specifically illustrated. Of course those skilled in the art will readily understand that the described embodiment is only of a exemplary form that the invention may take and that various changes and modifications may be made without departing from the spirit and scope of the invention, as defined by the appended claims.

What is claimed is:

1. A lighting system for a vehicle of the type steered by a handlebar having a handlebar cover comprising a pair of lights disposed on transversely opposite sides if an axis about which said handlebar is dirigible, a single lens cover covering both of said lights, said handlebar cover having a downwardly extending portion over a central portion of said lens cover and between the lights of said pair for providing a visual separation between the lights of said pair.

2. A lighting system as set forth in claim 1, wherein the pair of lights comprise headlights.

3. A lighting system as set forth in claim 2, wherein the downwardly extending portion depends to a position below a horizontal line passing through the centers of the headlights.

4. A lighting system as set forth in claim 3, further including left and right turn flasher lights disposed behind the single lens cover and having their centers lying on a horizontal line vertically offset from the horizontal line passing through the centers of the headlights.

5. A lighting system as set forth in claim 4, wherein the centers of the turn flasher lights are disposed outwardly from the centers of the headlights.

6. A lighting system as set forth in claim 5, wherein the downwardly extending portion depends to a position below a horizontal line passing through the centers of the turn flasher lights.

7. A lighting system as set forth in claim 6, wherein the line passing through the centers of the turn flasher lights lies vertically above the horizontal line passing through the centers of the headlights and completely below the turn flasher lights.

8. A lighting system as set forth in claim 3. wherein the transverse width of the downwardly extending portion narrows in a vertically downward direction.

9. A lighting system for a vehicle of the type steered by a handlebar having a handlebar cover comprising a pair of lights disposed on transversely opposite sides if an axis about which the handlebar is dirigible, a single lens cover covering both of the lights and supported for vertical adjustment behind an opening in the cover, the portion of said handlebar cover defining the opening and the single lens cover having overlapping portions that prevent any direct view behind said opening regardless of the adjusted position of said single lens cover.

10. A lighting system for a vehicle of the type steered by a handlebar as set forth in claim 9, wherein the pair of lights are supported by an inner lens to which the single lens cover is affixed and the inner lens has respective portions cooperating with respective of the lights for reflecting the light therefrom through the respective side of said single lens cover.

11. A lighting system for a vehicle of the type steered by a handlebar as set forth in claim 10, wherein the single lens cover, inner lens and lights are supported for pivotal adjustment about a horizontally disposed axis.

12. A lighting system for a vehicle of the type steered by a handlebar as set forth in claim 11, wherein the horizontally disposed axis is defined by at least one pivot pin and socket opening defined by respective of the inner lens and the handlebar cover.

13. A lighting system for a vehicle of the type steered by a handlebar as set forth in claim 12, wherein there are a pair of transversely spaced pivot pins and socket openings.

14. A lighting system for a vehicle of the type steered by a handlebar as set forth in claim 13, wherein the pivot pins are carried by the inner lens and the socket openings are formed by the handlebar cover.

15. A lighting system for a vehicle of the type steered by a handlebar as set forth in claim 12, wherein there is further provided an engaging recess and an engaging projection on respective of the inner lens and the handlebar cover for limiting the total degree of pivotal movement.

16. A lighting system for a vehicle of the type steered by a handlebar as set forth in claim 15, wherein an elastic element is disposed between the engaging recess and the engaging projection.

17. A lighting system for a vehicle of the type steered by a handlebar as set forth in claim 11, wherein the handlebar cover has a downwardly extending portion that narrows in a vertically downward direction over a central portion of the lens cover and between the lights of said pair for providing a visual separation between the lights of said pair.

18. A lighting system for a vehicle of the type steered by a handlebar as set forth in claim 17, further including left and right turn flasher lights disposed behind the single lens cover and having their centers lying on a horizontal line vertically below a horizontal line passing through the centers of the headlights.

19. A lighting system for a vehicle of the type steered by a handlebar as set forth in claim 18, further including a positioning light positioned below the headlights and the lower end of the cover downwardly extending portion.

20. A lighting system for a vehicle of the type steered by a handlebar as set forth in claim 19, wherein there is further provided an engaging recess and an engaging projection on respective of the inner lens and the handlebar cover for limiting the total degree of adjustment.
